(19) United States
(12) Patent Application Publication
(10) Pub. No.: US 2009/0084874 A1
(43) Pub. Date: Apr. 2, 2009

(54) METHOD OF PRODUCING NANOPARTICLES AND STIRRED MEDIA MILL THEREOF

(76) Inventors: Hilaal Alam, Karnataka (IN); Sourav Sen, Karnataka (IN)

Correspondence Address: Vern Maine & Associates, 100 MAIN STREET, P O BOX 3445, NASHUA, NH, 03061-3445, US

(21) Appl. No.: 11/577,371

(22) PCT Filed: Aug. 9, 2006
(86) PCT No.: PCT/IN06/00286

§ 371 Date: Apr. 17, 2007

(30) Foreign Application Priority Data
Dec. 14, 2005 (IN) 1827/CHE/2005

(51) Int. Cl. B82B 3/00; B02C 17/16

(52) U.S. Cl. 241/21; 241/172; 977/900

(57) ABSTRACT

The field of invention is related to a method of producing nanoparticles of less than 100 nm using a stirred media mill and a novel stirred media mill for producing the nanoparticles. The dead zones present in the stirred media mill, are the main cause of long time grinding and wide size distribution of product and is rectified in our design by optimum design of stirrer which will transfer the energy to beads at all parts in the chamber homogeneously for efficient and fast. The invention also discloses the design and operating conditions for production of nanoparticle in stirred media mill.

### FIELD OF INVENTION

The field of invention is related to a method of producing nanoparticles using stirred media mill and a novel stirred media mill for producing the nanoparticles. The invention also discloses the design and operating conditions for production of nanoparticle in stirred media mill.

### BACKGROUND OF THE INVENTION

Stirred media mill which is also called as attrition mill, stirred bead mill and stirred ball mill. Presently stirred media mills are in existence and they are used in paint industries for dispersion of paints, for ink manufacturing, dispersion of dyes, etc. Present stirred media mill can't produce nanoparticle, because of its incapable design and lack of knowledge on operating conditions. Present stirred media mills are designed to operate at low speed, and they use bigger size beads, they use dilute slurry, there is more clearance between chamber and stirrer pins, these are all main drawbacks in the present design.

Stirred media mill is a kind of size reduction equipment used for fine and ultra fine grinding. Stirred media mill consists of one cylindrical chamber in which grinding media (grinding beads/grinding balls) are filled at certain volume of the grinding chamber and a stirrer is used to make collision between the grinding media. Micronized powder is fed to the chamber in slurry form or as dry powder, particle breakage is taking place if the particle is captured between the grinding media contacts and grinding media and chamber wall contacts.

The energy required for particle size reduction is given through the stirrer then it transfers to the grinding media (micronized balls) and then grinding media transmits the energy to the particle during collision between grinding media. The distribution of energy from stirrer to grinding media should be homogeneous. Other wise there will be stagnant regions and size reduction will not be there at those places and consequently this will affect the product quality (i.e. the product will have both fine particle as well as ungrounded feed particle that will make it wider size distribution generally undesired one).

Generally the dead zones are present at the bottom of the grinding chamber, between two stirrer pins and a layer of dead zone at the chamber wall. In order to eliminate the dead zone stirrer design is so important, distance between pins in the stirrer, pin diameter, pin length, the gap between pin tip and chamber wall.

Grinding media wear and wear of the grinding media chamber are other problems, which will contaminate the product. Existing stirred media mills (also known as attritor, stirred bead mill, stirred ball mill) are generally used for paint industry (dispersion of pigments), ceramic industry (alloy making), paper industry (grinding of CaCO₃, etc), etc. At present stirred media mill suffers from contamination, high power consumption, and lack of knowledge of the optimized operating conditions (inefficient in grinding). Also, the existing mills are designed to operate at low rpm (to avoid contamination, i.e. wear of grinding chamber), and will take at least 20 hours of grinding to achieve the particle size that this process can do it at 45 minutes.

NETZCH, USA is designing a stirred media mill, which uses a sieve for the out let of nanoparticle during grinding in continuous mode of operation. Sieving of nanoparticle is practically not possible if so the product throughput will be less. It cannot be used for size reduction from micron size to nanosize. It is applicable only for the size reduction in the order of 10-20 times. High contamination and wider size distribution of products. They use a disc type stirrer, which is not efficient in energy transfer when compare to pins.

There are two top players in the world for stirred media mill supply. They are Union Process and Netzch. Their design is not capable to produce the particle size distribution in comparison to the process mentioned. In our process viscosity and surface modification takes place. This eases the size reduction process.

### PRIOR ART

1. Agglomeration and breakage of nanoparticles in stirred media mills—a comparison of different methods and models•ARTICLE Chemical Engineering Science, Volume 61, Issue 1, January 2006, Pages 135-148M. Sommer, F. Stenger, W. Peukert and N. J. Wagner

The increasing industrial demand for nanoparticles challenges the application of [symbol] stirred media mills [symbol] to grind in the sub-micron size range. It was shown recently [Mende et al. 2003. Mechanical production and stabilization of submicron particles in [symbol] stirred media mills. [symbol] Powder Technology 132, 64-73] that the grinding behavior of particles in the sub-micron size range in [symbol] stirred media mills [symbol] and the minimum achievable particle size is strongly influenced by the suspension stability and thus the agglomeration behavior of the suspension. Therefore, an appropriate modeling of the process must include a superposition of the two opposing processes in the [symbol] mill [symbol] i.e., breakage and agglomeration which can be done by means of population balance models. Modeling must now include the influence of colloidal surface forces and hydrodynamic forces on particle aggregation and breakup. The superposition of the population balance models for agglomeration and grinding with the appropriate kernels leads to a system of partial differential equations, which can be solved in various ways numerically. Here a modified h-p Galerkin algorithm which is implemented in the commercially available software package PARSIVAL developed by CiT (CiT GmbH, Rastede, Germany) and the moment methodology according to [Diemer and Olsen. 2002a. A moment methodology for coagulation and breakage problems: Part I—analytical solution of the steady-state population balance. Chemical Engineering Science 57 (12), 2193-2209; Diemer and Olsen. 2002b. A moment methodology for coagulation and breakage problems: Part II—moment models and distribution reconstruction. Chemical Engineering Science 57 (12), 2211-2288] are used and compared to explicit data on alumina. This includes a comparison of the derived particle size distributions, moments and its accuracy depending on the starting particle size distribution and the used agglomeration and breakage kernels. Finally, the computational effort of both methods in comparison to the prior mentioned parameters is evaluated in terms of practical application.
2. Nano-milling of pigment agglomerates using a wet stirred media mill: Elucidation of the kinetics and breakage mechanisms•ARTICLE Chemical Engineering Science, Volume 61, Issue 1, January 2006, Pages 149-157 Ecevit Bilgili, Rhye Hamey and Brian Scarlett

The present study concerns the production of pigment nanoparticles in a wet-batch [symbol] stirred media mill [symbol] with polymeric [symbol] media. [symbol] The breakage kinetics and mechanisms were investigated using size-discrete population balance models (PBMs). The temporal variation of the particle size distribution was measured via dynamic light scattering. Considering the G-H model, a time-invariant PBM, and a time-variant PBM, the specific breakage rate parameters and breakage distribution parameters were identified. It is found that the breakage rate is not first-order and that a delay time exists for the breakage of nanoparticles. The time-variant PBM captures all these features and suggests a transition from deagglomeration of agglomerates to the breakage of primary particles. The analysis of the breakage distribution parameters suggests splitting as the dominant mechanism as opposed to attrition or massive fracture.
3. The influence of suspension properties on the grinding behavior of alumina particles in the submicron size range in stirred media mills•ARTICLE Powder Technology, Volume 156, Issues 2-3, 23 Aug. 2005, Pages 103-110 Frank Stenger, Stefan Mende, Jörg Schwedes and Wolfgang Peukert

The paper shows the possibility to produce alumina nanoparticles in a [symbol] stirred media mill [symbol] by an appropriate adjustment of the suspension properties and the milling parameters. Besides a high electrostatic suspension stability that can be realised for metal oxides by means of pH value adjustment small grinding beads favour the production of alumina particles with a median particle size of around 10 nm. In addition to size reduction mechanochemical changes and the formation of alumina hydroxide are detected during wet grinding of alumina. This is analysed by means of X-ray diffraction analysis (XRD), thermogravimetry (TG) and dynamic scanning calorimetry (DSC) measurement and a quantitatively good agreement between the three methods could be obtained. Further, it is proved that the hydroxide produced dissolves at pH values lower than 5 thus influencing the grinding process under these conditions.
4. Nanomilling in stirred media mills•ARTICLE Chemical Engineering Science, Volume 60, Issue 16, August 2005, Pages 4557-4565 Frank Stenger, Stefan Mende, Jörg Schwedes and Wolfgang Peukert

This paper investigates the production of stable nanoparticle suspensions. The experimental set-up allows the online measurement of the most important electrochemical properties and the particle size distribution of the product suspension as well as an adjustment of the pH-value for stabilization during the comminution process. Electrostatic stabilization is a strong tool to produce stable nanoparticle suspensions for sparingly soluble oxide components. In this contribution the influence of different operational parameters at stable suspensions properties on the grinding result in the nanometer size range is presented. In addition to alumina, the concept of electrostatic stabilization during wet grinding of nanoparticles is also applied to tin oxide.
5. Control of aggregation in production and handling of nanoparticles•ARTICLE Chemical Engineering and Processing, Volume 44, Issue 2, February 2005, Pages 245-252 Wolfgang Peukert, Hans-Christoph Schwarzer and Frank Stenger

In product engineering of particulate systems, the property function relates the dispersity to the product properties, whereas the process function shows how to produce the required dispersity. These principles are applied to the production of nanoparticles. Nanoparticles are controlled by surface forces. Due to their high mobility nanoparticles are unstable and may coagulate rapidly if the particles are not stabilized. Stabilization is achieved by tailoring the particulate surfaces, e.g. through repulsive double layer forces. Macroscopic properties are thus controlled by microscopic control of the interfaces, i.e. we bridge the gap between the molecular level and material properties. These principles are generally valid and are thus applied to precipitation and to nanomilling in stirred [symbol] ball [symbol] mills. [symbol] The mean particle size in precipitation can be controlled by either the mixing intensity or the surface charge density of the particles. In [symbol] stirred media mills [symbol] oxide particles as small as 10 nm can be achieved by stabilizing the particles appropriately.
6. Mechanical production and stabilization of submicron particles in stirred media mills•ARTICLE Powder Technology, Volume 132, Issue 1, 29 May 2003, Pages 64-73 S. Mende, F. Stenger, W. Peukert and J. Schwedes

A joint research project between the Technical University of Braunschweig and the Technical University of München investigates the possibilities for the production of stable product suspensions in a particle size range smaller than 100 nm. This paper shows the experimental setup which allows the measurement of the most important electrochemical properties and the analysis of the particle size distribution of the product suspension as well as an adjustment of the pH value for stabilization during the comminution process. Results for comminution of fused corundum with different grinding media materials and grinding media sizes are shown. In addition, results showing the influence of the electrostatic stabilization on the grinding progress are presented. Further, the rheology of the product suspension is examined depending on grinding progress and suspension stability.
7. Investigation of the grind limit in stirred-media milling•ARTICLE International Journal of Mineral Processing, Volumes 44-45, March 1996, Pages 607-615H. Cho, M. A. Waters and R. Hogg

While it has often been suggested that there are limits to the extent to which particle size can be reduced by comminution, experimental evidence for the existence of such “grind limits” is scarce and generally inconclusive. An experimental study of long-time grinding of crystalline quartz in a stirred-media mills has been carried out with the specific aim of identifying the limit of grinding. Product size distributions have been characterized using a combination of laser diffraction/scattering; centrifugal sedimentation, dynamic light scattering and BET surface area measurement. Qualitative examination of the ground products by transmission electron microscopy has also been performed. The results of the investigation are consistent with a grind limit in the region of 40 to 50 nm for this system. In terms of breakage parameters, it appears that there is a decrease in breakage rates at sizes smaller than about 0.5 μm and that primary breakage distributions become progressively narrower at submicron sizes. The above articles and papers are related to nano particle production in stirred media mill.

In these Investigations
1. The minimum time of grinding required achieving the particle size less than 100 nm is 8 hours.
2. Breakage of beads are more
3. Production quantity is very less.
4. It requires specific energy of 80 kW/kg.
5. These are just academic research can't be implemented (commercialized).

### In Present Invention

1. The time of grinding required achieving the particle size less than 100 nm is about 45 minutes.
2. There are no structural changes in my design but it is optimized to achieve nanoparticle in 45 minutes and reduce contamination.

The operating conditions will be the same for metal oxide nanoparticle, silicon etc.,

| | | Company | |
|---|---|---|---|
| | PAT. NO. | name | Title |
| 1 | 6,592,903 | Netzsch | Nanoparticulate dispersions comprising a |
| | | | synergistic combination of a polymeric |
| | | | surface stabilizer and dioctyl sodium |
| | | | sulfosuccinate |
| 2 | 6,467,897 | Netzsch | Energy curable links and other compositions |
| | | | incorporating surface modified, nanometer- |
| | | | sized particles |
| 3 | 6,375,986 | Netzsch | Solid dose nanoparticulate compositions |
| | | | comprising a synergistic combination of a |
| | | | polymeric surface stabilizer and dioctyl |
| | | | sodium sulfosuccinate |
| 4 | 6,267,989 | Netzsch | Methods for preventing crystal growth and |
| | | | particle aggregation in nanoparticulate |
| | | | compositions |

| | | Company | |
|---|---|---|---|
| | PAT. NO. | name | Title |
| 1 | 6,890,715 | Hosokawa | Sensors of conducting and insulating |
| | | | composites |
| 2 | 6,855,426 | Hosokawa | Methods for producing composite |
| | | | nanoparticles |
| 3 | 6,723,279 | Hosokawa | Golf club and other structures, and novel |
| | | | methods for making such structures |

| | | Company | |
|---|---|---|---|
| | PAT. NO. | name | Title |
| 1 | 6,709,622 | Union process | Porous nanostructures and method of |
| | | | fabrication thereof |
| 2 | 6,372,402 | Union process | Developer compositions and processes |
| 3 | 6,346,357 | Union process | Developer compositions and processes |

### OBJECTIVES OF THE INVENTION

An objective of the invention is to provide a method of producing nanoparticles using a stirred mill.

A further objective of the invention is to provide a stirred media mill capable of producing nanoparticles.

Another objective of the invention is to produce nanoparticles within a short time of grinding.

Yet another objective of the invention is to produce nanoparticles suspension.

### DRAWINGS OF THE PRESENT INVENTION

The present invention shall now be fully described with reference to the accompanying drawings in which,

FIG. 1 is a stirred media mill, which shows the various parts of the mill.

### STATEMENT OF THE PRESENT INVENTION

The present invention is related to a method of producing nanoparticles of size less than 100 nm using stirred media mill, said method comprising steps of: grinding slurry having particle concentration ranging between 20 to 50 wt % with beads occupying 60 to 90% of the mill volume at pin-tip velocity ranging between 6 to 10 m/s, maintaining viscosity and pH of the slurry during the grinding, and obtaining nanosized particle in time duration ranging between 40-45 minutes; and a stirred media mill for producing nanoparticles of size less than 100 nm, wherein the mill comprises: each pin fitted onto shaft perpendicular to previous pin at distance of less that 15 mm, wherein there is a gap of about twice the size of the beads between chamber wall and pin tip, and clearance of about 3 mm-5 mm between shaft end and bottom of grinding chamber.

### DETAILED DESCRIPTION OF THE INVENTION

Accordingly, the preset invention is related to a method of producing nanoparticles of size less than 100 nm using stirred media mill, said method comprising steps of:
a. grinding slurry having particle concentration ranging between 20 to 50 wt % with beads occupying 60 to 90% of the mill volume at pin-tip velocity ranging between 6 to 10 m/s,
b. maintaining viscosity and pH of the slurry during the grinding, and
c. obtaining nanosized particle in time duration ranging between 40-45 minutes.

In an embodiment of the present invention, wherein the method further comprises the bead of size ranging between 0.3 mm to 1.2 mm.

In yet another embodiment of the present invention, wherein the method further comprises the time duration is about 45 minutes.

In still another embodiment of the present invention, wherein the method further comprises the particle concentration is about 33 wt %.

In still another embodiment of the present invention, wherein the method further comprises the bead occupies about 70% of the mill volume.

In still another embodiment of the present invention, wherein the method further comprises the pin tip velocity is about 7.1 m/s.

In still another embodiment of the present invention, wherein the method further comprises the viscosity is maintained with water.

In still another embodiment of the present invention, wherein the method further comprises the pH is maintained with acid and/or alkali.

In still another embodiment of the present invention, wherein the method further comprises the bead density is ranging between 2.8 to 16 g/cc.

Another main embodiment of the present invention is a stirred media mill for producing nanoparticles of size less than 100 nm, wherein the mill comprises: each pin fitted onto shaft perpendicular to previous pin at distance of less that 15 mm, wherein there is a gap of about twice the size of the beads between chamber wall and pin tip, and clearance of about 3 mm-5 mm between shaft end and bottom of grinding chamber.

In yet another embodiment of the present invention, wherein the method further comprises grinding chamber and lid lined with ceramic.

In still another embodiment of the present invention, wherein the method further comprises the grinding chamber outlet filter having sieve size of about 300 micron.

Quality of the nanoparticle is based on nanoparticle size, dispersability of nanoparticle, surface energy of nanoparticle, purity of the nanoparticle and applicability of nanoparticle. Through this process particle size well below 100 nm can be obtained with good dispersability of nanoparticle and high purity, high specific surface area, surface modified nanoparticle, and of platy and spherical shapes.

Operating conditions for the stirred media mill for producing the nanoparticles are given below:
Bead size is 0.4 mm-0.6 mm
Pin tip velocity is 6-10 m/s (stirrer speed)
Slurry concentration is 20-50% (wt % of particle in slurry)
Bead density of 4.0 g/cc, 6.0 g/cc and above 7.0 g/cc (i.e from 2.8 to 16 g/cc)
Bead loading is 30-90% of mill volume
Slurry loading (material loading) 70-100% of void volume of bed of beads (grinding media)
Viscosity is modified during grinding
Surface modified using polymeric surfactants

In this design there is no contamination of product, no wear of grinding media and grinding chamber, short time (45 min) of grinding to get the entire particle less than 100 nm. Narrow particle size distribution is obtained, maximum energy utilization for size reduction process and energy consumption is less. All the inorganic nanoparticle can be produced with our optimized design and operating conditions.

There are three definitions for nanoparticle only based on size of the particle.
1. Nanoparticle is defined as any particle having size less than or equal to 999 nm. Since the unit of expression is changed. It is convenient to express 999 nm than 0.999 μm. (Used by particle technology people).
2. Nanoparticle is defined as any particle having size less than 300 nm. The outstanding behavior of nanoparticle starts at size range between 200 nm-300 nm. That is, the transition in the character of micro particle to nanoparticle takes place at 300 nm. Nanoparticle behaves quite differently than the micro and macro particle. (Used by medical, nanocomposites, material technology people).
3. Nanoparticle is defined as any particle having size less than 100 nm. The unit of expression is found to reasonable at this size range. (Used by physics, chemistry, and Nanotechnology people).

Based on the material type nanoparticle are inorganic (metal, metal oxides, ceramic, non metal, semimetal) or organic (polymers). For example: Metal nanoparticle: Iron, Metal oxides nanoparticle: Ferric oxide, Ceramic nanoparticle: silicon carbide, Non-metals: Clay nanoparticle, CaCO₃ nanoparticle, carbon nanoparticle, talc nanoparticle, silica nanoparticle, TIO2 Nanoparticle, alumina nanoparticle, etc.

### Semi-Metal: Silicon

Organic nanoparticle: Poly acrylic amide nanoparticle, poly acrylic acid nanoparticle, polystyrene nanoparticle, etc.,

### DEFINITION OF TERMS

### Slurry Concentration

Weight percentage of particle (powder of the material to be ground) in the slurry.

Slurry is prepared with water.

### Pin Tip Velocity

This is angular velocity of the stirrer pin tip.

It is denoted by V=rω=2rN/60. Its unit is m/s.

### Bead Loading

It is the percentage grinding chamber volume filled with beads.

### Bead Density

Density of the beads, which is based on the type of material.

### Slurry Loading (Material Loading)

Amount of slurry filled in the grinding chamber.

### Bead Size

Size of the grinding beads

Bead material

### Material of Construction of Beads

Feed particle size

Size of the particle that is going to be ground

### Slurry Viscosity

Viscosity of the particle (powder)-water suspension.

### Stressing Frequency

Frequency of stressing events or collision events between the beads

### Stress Number

Number of stressing events or collision taking place inside the grinding chamber.

### Stress Intensity

This is the force exerted at a stressing event or collision between two beads.

### Breakage Function

This decides how many collisions are required for breaking a particle. This is based on collision intensity

### Selection Function

This decides how many times a particle is getting attrited/crushed/captured at media contacts in a given time of grinding. This is based on stress number and stress frequency.

### Bead Size, Free Space, Stirrer Diameter, Vessel Diameter, Pin Tip Velocity, Bead Density, and Time of Grinding Relations

Stress intensity of grinding beads is directly proportional to the grinding media density and it is given by

SI_{Gm}=d_{GM}³ρ_{GM}Vₜ²

Above Equation relates stress intensity as function of diameter of grinding media (d_{Gm}); grinding media density (ρ_{Gm}) and pin tip velocity (Vₜ).

Stress frequency is given by

$$SF = {{ω}_{d} ( \frac{{D}_{d}}{{D}_{b}} )}^{2} T$$

Above Equation relates stress frequency with angular velocity (ω_{d}), time of grinding (T), stirrer diameter (D_{d}) and diameter of the beads (D_{b}).

Volume related kinetic bead energy in stirred media mill is given by

$${E}_{VB} = ζ ( 2 \frac{D}{{D}_{R}} ) {u}^{2} {ρ}_{B}$$

Above Equation relates volume related kinetic bead energy as function of pin tip velocity (u), grinding media density (ρ_{B}), diameter of the stirrer (D_{R}) and diameter of the grinding chamber (D) and fractional constant for stirred media mill (ξ).

Specific energy (energy consumption per tonne of product)

Specific energy is the measure of energy consumption for the grinding and it also tells about the product fineness. High specific energy produces higher product fineness.

Specific energy input is given by

Eₘ=stress intensity×stress frequency

Above equation relates the specific energy with stress intensity and stress frequency. Higher the collision intensity higher the rate of breakage, which is, obtained with higher bead density and bead size, bead density varies for different materials 4.0 g/cc for talc to 16.0 g/cc for metals depending on the materials it varies from 2.8-16 g/cc and bead size is 0.3-1.2 mm. Higher the stressing frequency higher the rate of breakage, which minimizes the time of grinding and it is obtained with higher pin tip velocity and it is optimum at 6 m/s-10 m/s. slurry concentration is about 20-50% by weight.

Higher the probability of particle captured between the beads higher the rate of breakage and it is achieved by high slurry concentration viscosity modification, higher the stress number higher the rate of stressing, which is achieved by the higher beads loading above 50% of the mill volume. Higher nanoparticle production is achieved by allowing more free space in the mill that is required to avoid the shortage of space during increase in material volume.

The present design is based on the intensive research on the stirrer design, clearance between stirrer pins and attritor chamber walls, material of construction, lining of the chamber, operating conditions such as beads diameter, bead loading, material loading for dry grinding and slurry loading for wet grinding, slurry concentration, viscosity modification during milling.

The stirred media mill is based on the attrition of particle between the beads. Breakage of particle between beads is based on the stress intensity of beads (i.e. when two beads stressed each other or collide each other the force acted on the stressing/colliding event is called stress intensity which is based on the bead density pin tip velocity and slurry concentration. Which decides the breakage of particle), stressing frequency of beads (the frequency of the stressing/collision events between the beads which decides the how quick is the size reduction), probability of particle captured between the beads and stress number. Stress number is defined as the number of stressing events taking place inside the mill. If the stress number is more, then quicker will be the required size reduction. Stress number is based on the bead size and bead loading; probability of particle captured between the beads is based on the slurry viscosity, slurry concentration, and slurry loading and feed particle size.

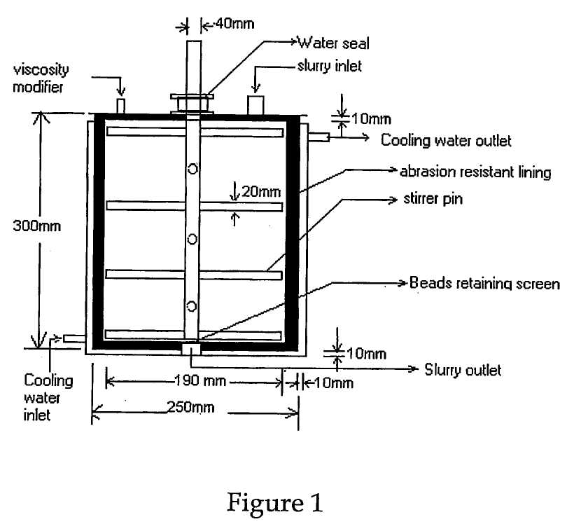

FIG. 1 shows a stirred media mill for capable of producing nano particles. The various parts of the mill are explained below:

### Cooling Jacket

Grinding chamber is covered with a cooling jacket to cool the chamber during grinding.

### Grinding Chamber

It is a cylindrical chamber lined with abrasive resistant ceramic.

### Grinding Chamber Cover

Grinding chamber cover is also lined with abrasive resistant ceramic lining.

### Slurry Inlet/Beads Inlet

Through slurry inlet hole the beads and feed material in slurry form is fed to the grinding chamber, which is closed during the grinding. Non-return valve is used.

### Slurry Outlet

Through slurry outlet hole the product in slurry form is drawn, which is closed during grinding.

### Beads Retaining Screen

This is the screen of 300 micron size, which is placed at the slurry outlet to retain the beads

### Viscosity Modifier Inlet/Surfactant Inlet

This is a small diameter hole used to add surfactant and viscosity modifier, which has a non-return valve.

### Stirrer

A cylindrical shaft consisting of radial pins placed at different radial positions. Stirrer is coated with ceramic.

Water seal

Water seal is used at the shaft entrance to avoid the leakage of the material during grinding.

### Method of Producing the Nanoparticles Using the Stirred Mill are Given Below:

1. Process
   i. Loading beads to the chamber
   ii. Loading slurry to the chamber (Note the initial pH of the slurry)
   iii. Switch on the cooling water circulation.
   iv. Grinding for 10 minutes
   v. Adding surfactant (poly acrylic acid at 500 ppm in case of talc and alumina, poly vinyl alcohol at 500 ppm in case of silica)
   vi. Add NaOH/HCl to bring back to initial pH of the slurry
   vii. Viscosity modification with distilled water
   viii. Continue grinding for another 10 minutes
   ix. Add distilled water to bring it back to original viscosity
   x. Continue grinding for another 10 minutes
   xi. Add distilled water to bring it back to original viscosity
   xii. Add 1% methoxy silane
   xiii. Continue grinding for another 15 minutes
   xiv. Stop the grinding and open the outlet valve and inlet valve
   xv. Collect the slurry from the outlet with the help of suction.
   xvi. Wash the beads with water and it is ready for another batch/other material grinding.
   xvii. Collected slurry is nothing but nanoparticle suspension
   xviii. Slurry concentration is increased by evaporating portion of water, to sell it in slurry form for paint industry.
   xix. Slurry is spray dried/dried in tray drier and ball milled.

During grinding in stirred media mill, erosion takes place at the attritor chamber and stirrer and it contaminates the ground nanoparticle. Lining with abrasive resistant ceramic lining eliminates erosion of the chamber wall and stirrer. In stirred media mill the energy given to the stirrer is distributed to the beads, which then transfers to the particles. Designing of stirrer and stirrer pins for equal distribution of shaft energy into beads is critical. To avoid any stagnant region of beads the gap between the stirrer pins and chamber wall is kept at 5 mm. Using zirconia beads and tungsten beads reduces the wear of grinding media.

The invention is further elaborated with the help of following examples. However, such examples should not be construed to limit scope of the invention

### EXAMPLES

Following are the few observations made in the present invention.
1. It is observed that the dead zones present in the stirred media mill are a main cause of long time grinding and wide size distribution of the product. This is rectified in our design by optimum design of stirrer, which will transfer the energy to beads at all parts in the chamber homogeneously.
2. Shaft diameter and pin diameter are proportionate to the grinding chamber diameter. Pins are fitted in the shaft in such a way that every immediate next pin is perpendicular to the previous pin. The distance between the two pins is less than 15 mm. The Entire shaft inside the grinding chamber is fitted with pins with less than 15 mm distance. Scale up in the present design and procedure doesn't give the same result as that of laboratory mill result.
3. The gap between the chamber wall and pin tip is kept twice the size of the largest bead size used (For Ex. If the bead size used is 0.4-0.6 mm then the gap between the chamber wall and pin tip is 1.2 mm). Increase in the gap gives dead zone and leaves ungrounded particles while, decrease in the gap results in beads crushing and high bead wear and chamber wear.
4. The designed operating conditions are in such a way that it will make the entire particle undergo for primary breakage, secondary breakage and so on. So it makes the required product size at nanometer level within short period.
5. Automatic viscosity modification and surface modification takes place during size reduction.
6. Bead size is 0.3 mm-1.2 mm which is found to be optimum, which will give high selection function (more number of beads at a given volume), high bead energy (high breakage), low grinding media wear, and less bead cost when compare to further smaller bead size.
7. Pin tip velocity is 7.1 m/s (stirrer speed), which is optimum for high selection function and high breakage function, low wear value, and optimum energy supply.
8. Slurry concentration is 33% (wt % of particle in slurry). Feed material is fed in slurry form to the mill.
9. Bead density of 4.0 g/cc (zirconia beads) is used to produce particle having hardness less than 4, Bead density of 6.0 g/cc (zirconia beads) is used to produce particle having hardness less than 6, Bead density above 1.0 g/cc (Tungsten carbide) is used to produce particle having hardness more than 6.0 (selection of bead density is based on bead size and hardness of the material to be ground).
10. (Grinding media) Bead loading is 75% of mill volume. Bead loading is an important parameter, which decides the number of beads, number of collision, and particle to beads ratio and energy consumption. Higher the bead loading higher the breakage rate but high the energy wastage and beads wear.
11. The free space allowed in the mill is very critical for the expansion of slurry volume as the number of particles is increases during grinding. It should be in such a way that all the free space should be occupied by the grinding beads during grinding. Presently people don't understand this process and they use bead loading more than 90% of mill volume which do not give sufficient space for new particle production and results in high bead wear, high power loss, lower grinding rate. Very low beads loading also results in poor results, like long grinding time, wide particle size distribution, presence of feed particle in the product.
12. Slurry loading (material loading) has to be optimum to achieve high throughput, low power consumption and short time of grinding. We use to fill the 100% of the void space at the bed of beads.
13. Viscosity modification is very important in grinding. During grinding the viscosity of slurry increases rapidly and the probability of particle captured at media contacts is less (slippage of particle at media contact is high) and it reduces the bead energy (as the bead travels through the viscous slurry). So viscosity is modified during grinding. Too low viscosity also will result in inefficient grinding.
14. Surface modification of the particles by polymeric surfactant. During grinding as the particle approaches the nano size its surface free energy is getting increased and it result in particle agglomeration and low grinding rate (size reduction becomes less). Surface of the particle is modified with surfactants to reduce the surface free energy of the particles and thereby making the flaws in the particle to grow and get size reduction.
15. This method will allow direct particle size reduction from 100 micron size to less than 100 nm in a given operating conditions. No change of bead size or mill is required.
16. Presently there is no machine, which converts all the micronized powder charge to nanosize in a batch.
17. Easily scalable to any quantity.
18. Size reduction of more than 1000 (from 100000 nm to 100 nm and less) is achieved in a batch grinding.
19. Less grinding time (45 minutes) to achieve nanoparticle from micro particle.
20. No wear of beads and grinding chamber
21. High quality product.

### ADVANTAGES OF THE INVENTION

Wear of the beads is less
Easy separation of beads and nanoparticle
Any kind of nanoparticle can be produced.
Cost of production is less.
Short time of grinding.

### APPLICATIONS OF THE INVENTION

Nanoparticles of all the inorganic materials can be produced with high purity and low production cost.

Metal nanoparticles

Metal oxide nanoparticles

Mineral nanoparticles

Ceramic nanoparticles

Silicon nanoparticle

We claim:

1. A method of producing nanoparticles of size less than 100 nm using stirred media mill, said method comprising steps of:
a. grinding slurry having particle concentration ranging between 20 to 50 wt % with beads occupying 60 to 90% of the mill volume at pin-tip velocity ranging between 6 to 10 m/s,
b. maintaining viscosity and pH of the slurry during the grinding, and
c. obtaining nanosized particle in time duration ranging between 40-45 minutes.

2. A method as claimed in claim 1, wherein the bead is of size ranging between 0.3 mm to 1.2 mm.

3. A method as claimed in claim 1, wherein the time duration is about 45 minutes.

4. A method as claimed in claim 1, wherein the particle concentration is about 33 wt %.

5. A method as claimed in claim 1, wherein the bead occupies about 70% of the mill volume.

6. A method as claimed in claim 1, wherein the pin tip velocity is about 7.1 m/s.

7. A method as claimed in claim 1, wherein the viscosity is maintained with water.

8. A method as claimed in claim 1, wherein the pH is maintained with acid and/or alkali.

9. A method as claimed in claim 1, wherein the bead density is ranging between 2.8 to 16 g/cc.

10. A stirred media mill for producing nanoparticles of size less than 100 nm, wherein the mill comprises: each pin fitted onto shaft perpendicular to previous pin at distance of less that 15 mm, wherein there is a gap of about twice the size of the beads between chamber wall and pin tip, and clearance of about 3 mm-5 mm between shaft end and bottom of grinding chamber.

11. A stirred media mill as claimed in claim 10, wherein grinding chamber and lid lined with ceramic.

12. A stirred media mill as claimed in claim 10, wherein the grinding chamber outlet filter having sieve size of about 300 micron.
